(19) United States
(12) Patent Application Publication
(10) Pub. No.: US 2004/0075932 A1
(43) Pub. Date: Apr. 22, 2004

(54) Integrated magnetic data storage and optical disk data storage device

(76) Inventor: Scott Edward Watson, San Jose, CA (US)

Correspondence Address: Scott Edward Watson, 4841 Winton Way, San Jose, CA, 95124, US

(21) Appl. No.: 10/686,447

(22) Filed: Oct. 15, 2003

Related U.S. Application Data
(60) Provisional application No. 60/419,127, filed on Oct. 16, 2002.

(51) Int. Cl. G11B 19/02; G11B 21/02

(52) U.S. Cl. 360/69; 360/75

(57) ABSTRACT

An improved data storage device integrates a magnetic data storage means and optical data storage means onto a single chassis 326. A single printed circuit board 325 provides the electrical interconnections within the integrated magnetic and optical data storage device. A single interface connector 322 connects to a host system. A single power connector 323 connects to a host system.

### CROSS-REFERENCE TO RELATED APPLICATIONS

This application claims the benefit of Provisional Patent Application Ser. No. 60/419127 filed 2002 Oct. 16.

### FEDERALLY SPONSORED RESEARCH

Not Applicable

### SEQUENCE LISTING

Not Applicable

### BACKGROUND

1. Field of Invention

This invention relates to data storage devices, integrating a magnetic data storage device with an optical disk data storage device.

2. Description of Prior Art

Current personal computers (PCs) and similar devices contain a magnetic data storage device (such as a Hard Disk Drive—HDD) for storing digital data which, may be written, read, re-written or erased many times. Most PCs and similar devices also contain an optical data disk reader (Compact Disk—CD or Digital Versatile Disk—DVD) which can read pre-written information on a removable optical disk, but may also allow removable optical disks to be written, read, re-written or erased many times.

Historically, HDDs and DVDs have been independent peripherals to a PC; not all PCs had HDDs and not all PCs had DVDs (or its predecessor, the Compact Disk). Today, HDDs and DVDs are shipped in most PCs. Also, video game players now utilize both a HDD and DVD. Personal Video Recorders are based on the large data capacity and speed of a HDD to record video; these are typically used in video systems that also include a DVD.

These two devices complement one-another as the HDD typically has a very large data storage capacity (10 to 100 or more Gigabytes) and can read and write data very fast, while an optical DVD device can read and write to removable disks which contain 1 to 10 Gigabytes of information, but at slower data transfer rates. When a HDD and DVD are used together in a PC or similar system, the HDD may serve as a data buffer for the DVD, allowing temporary storage and faster data access than directly transferring data to and from DVD device. The HDD serves as a work-space for large data files (such as motion video) during creation and editing. Complimentary to this, an optical DVD device provides a method of writing a final edited copy of a data file to a removable DVD disk.

### Construction of Prior Art

FIG. 1A schematically shows the principal components of an HDD device 100. The HDD device 100 contains a magnetic disk 111 on which data is recorded. The magnetic disk 111 is mounted onto and rotated by a spindle motor 113. A magnetic head 112 writes and reads data onto the magnetic disk 111. The magnetic head 112 is mounted on a positioning means 114. The spindle motor 113 and head positioning means 114 are controlled by servo control means 116 and the microprocessor 120. A timing means 124 provides accurate time interval information to the microprocessor 120. The read channel means 115 provides encoding and decoding of digital data between the magnetic head 112 and the controlling microprocessor 120. The microprocessor command codes are stored in non-volatile memory 117. The microprocessor 120 caches data in volatile memory 118 during operation. The microprocessor receives commands and communicates with the host system (not shown) via the interface connector 122. A voltage regulation means 121 ensures proper conditioning of the power supplied by the host system thru the power connector 123. A power-storage means 119 stores electrical power for transient use when host power is lost. A printed circuit board 125 provides interconnecting circuitry between the interface connector 122, power connector 123, microprocessor 120, voltage regulation means 121, timing means 124, power-storage means 119, volatile memory 118, non-volatile memory 117, servo control means 116, and read channel means 115.

Similarly, FIG. 1B schematically shows a DVD device 200 which utilizes an optical disk 211 on which data is recorded. The optical disk 211 is mounted onto and rotated by a spindle motor 213. An optical head 212 writes and reads data onto the optical disk 211. The optical head 212 is mounted on a positioning means 214. The spindle motor 213 and head positioning means 214 are controlled by servo control means 216 and the microprocessor 220. A timing means 224 provides accurate time interval information to the microprocessor 220. The read channel means 215 provides encoding and decoding of digital data between the optical head 212 and the controlling microprocessor 220. The microprocessor command codes are stored in non-volatile memory 217. The microprocessor 220 caches data in volatile memory 218 during operation. The microprocessor receives commands and communicates with the host system (not shown) via the interface connector 222. A voltage regulation means 221 ensures proper conditioning of the power supplied by the host system thru the power connector 223. A power-storage means 219 stores electrical power for transient use when host power is lost. A printed circuit board 225 provides interconnecting circuitry between the interface connector 222, power connector 223, microprocessor 220, voltage regulation means 221, timing means 224, power-storage means 219, volatile memory 218, non-volatile memory 217, servo control means 216, and read channel means 215.

FIG. 2A shows a top view of a typical prior-art method of attaching an HDD device 100 and a DVD device 200 into a host system (not shown). The HDD chassis 126 is attached to host system mounting rails 416 via screws 415. The host system mounting rails 416 are attached to the host system chassis 400 by an attachment method 417. A host system interface connector 411 connects to the HDD interface connector 122. A host system power connector 412 connects to the HDD power connector 123.

Similarly, the DVD chassis 226 is attached to host system mounting rails 426 via an attachment method 425. The host system mounting rails 426 are attached to the host system chassis 400 by an attachment method 427. A host system interface connector 421 connects to the DVD interface connector 222. A host system power connector 422 connects to the DVD power connector 223.

FIG. 2B shows an end view of the host system chassis 400, onto which the HDD chassis 126 and DVD chassis 226 are mounted.

### Common Elements of Prior Art

It is easy to see the strong similarities between a HDD and DVD device. Some of these similar components are actually quite different in design due to different requirements of magnetic data storage and optical data storage. For example, redundant spindle motors are necessitated by different design requirements. While the HDD motor must rigidly hold a magnetic disk inside a sealed environment with materials carefully selected to control corrosion and contamination. The DVD motor generally allows removal of an optical data disk and hence must be open to the outside environment. As a second example, the redundancy of microprocessors has generally been necessitated by differences in data formats and methods of positioning the read/write elements over the disk.

Other components are similar or identical in design. The host interface connector is exactly the same, since standards such as IDE (Intelligent Drive Electronics) interface are adopted to simplify integration with the host computer. Electronic power requirements are also identical, as the host system and most peripheral devices have been standardized around 5 and 12 volt operation. Power regulation requirements are also the same, as integrated circuits are mostly designed to the same tolerances on voltage. Timing clock requirements are also generally the same, as the core microprocessors are designed to standard operating frequencies, for example: 500 megahertz (MHz). Printed circuit boards designs are very much the same, since the power and data-carrying requirements are the same.

Hence, when an HDD and DVD are concurrently used by a host system, many redundant internal components are employed. This larger number of components provides a greater number of possible failure points, reducing the reliability of the overall system. This larger number of components adds to the cost of the overall system.

Since the HDD and DVD are currently independent peripherals inside the host system, extra mounting structure and electrical interconnect circuitry must also be provided. This adds to the weight, volume, and number of components in the overall system. It also adds to product development time, manufacturing assembly time, and overall system cost. Significantly, these additional application-specific components provide more possible failure points, decreasing the reliability of the overall system.

### Objects and Advantages

The current invention reduces the number of components in the data storage device by eliminating redundant elements. This improves the reliability of data storage device while reducing its size and complexity.

A reduction of the total number of components in the assembled host system containing a HDD and DVD will therefore increase the reliability and allow a decrease the weight and volume of the assembled host PC.

### SUMMARY OF INVENTION

The present invention integrates a magnetic and optical data storage device to reduce the complexity of the interface to the host device, reduce the overall number of components in the DVD, HDD, and host device assembly and allow a reduction in overall weight and volume.

This invention may be regarded as an integrated HDD/DVD device with a single external mounting structure for the integrated device to the host PC. Further, a single electronics interface connector (such as a standard IDE interface) provides a means of communicating commands and data between the host PC and the HDD and DVD functions of the integrated device. A single power connection between the integrated device and the host PC and a single voltage regulation means is used to provide the 12 and 5 volts typically used by both the HDD and DVD components. A single timing means serves both HDD and DVD timing requirements. A single acceleration sensing means, also known as a shock sensor provides information to both HDD and DVD functions. A single non-volatile memory component is used to store HDD and DVD microprocessor commands during non-operation (power-off). A single volatile memory component is used to temporarily cache data from the HDD and DVD functions during operation. Since the DVD disks are typically much larger than HDD disks, the form factor of the integrated device would most likely follow current DVD standards.

### BRIEF DESCRIPTION OF DRAWINGS

FIG. 1A schematically shows the prior-art HDD device architecture.

FIG. 1A schematically shows the prior-art DVD device architecture.

FIG. 2A shows a top view of the prior-art mounting of a HDD device and DVD device into a host system.

FIG. 2B shows an end view of the prior-art mounting of a HDD device and DVD device into a host system.

FIG. 3 schematically shows the architecture of the integrated HDD/DVD device.

FIG. 4A shows a top view of the mounting of the integrated HDD/DVD device into a host system.

FIG. 4B shows a top view of the mounting of the integrated HDD/DVD device into a host system.

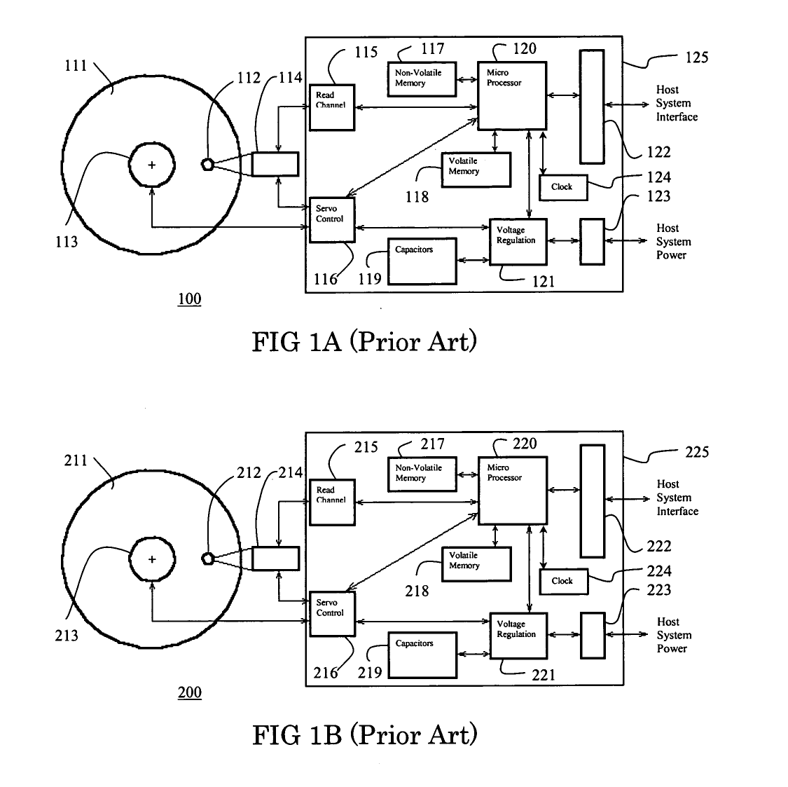

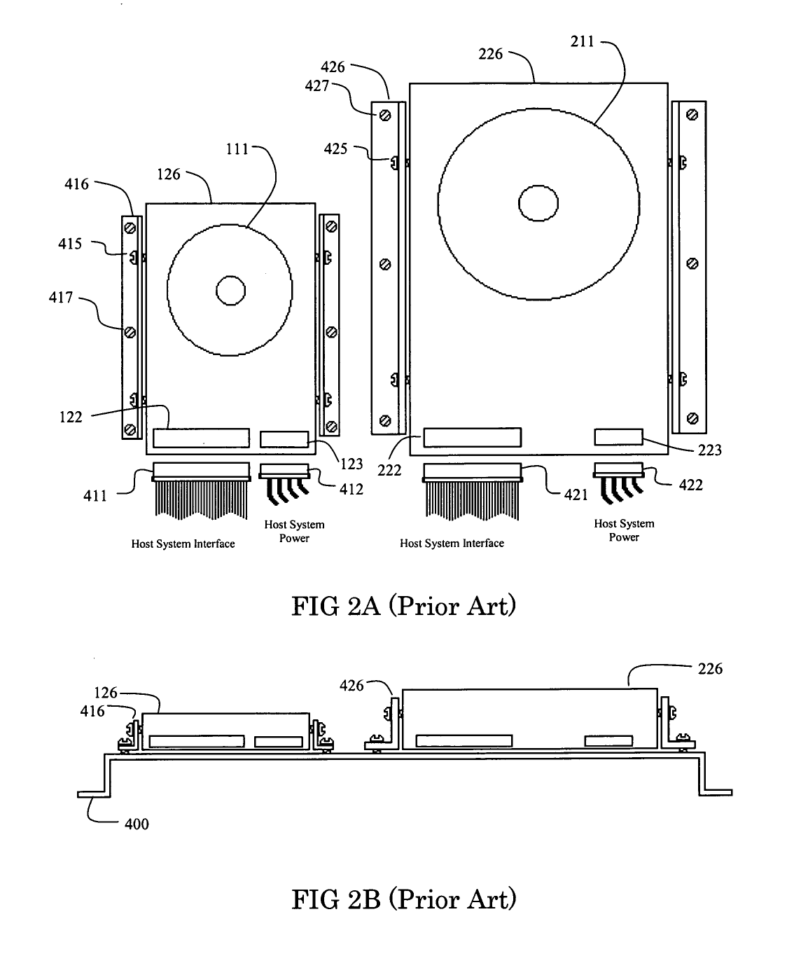

### REFERENCE NUMBERALS

110 Magnetic data storage device (HDD)

111 HDD magnetic disk

112 HDD magnetic read/write head

113 HDD spindle motor

114 HDD positioning means

115 HDD read channel means

116 HDD servo control means

117 HDD non-volatile memory

118 HDD volatile memory

119 HDD power storage means

120 HDD controlling microprocessor

121 HDD voltage regulation means

122 HDD interface connector

123 HDD power connector

124 HDD timing means

125 HDD printed circuit board

126 HDD chassis

200 Optical data storage device (DVD)

211 DVD optical disk

212 DVD optical read/write head

213 DVD spindle motor

214 DVD positioning means

215 DVD read channel means

216 DVD servo control means

217 DVD non-volatile memory

218 DVD volatile memory

219 DVD power storage means

220 DVD controlling microprocessor

221 DVD voltage regulation means

222 DVD interface connector

223 DVD power connector

224 DVD timing means

225 DVD printed circuit board

226 DVD chassis

300 Integrated HDD/DVD data storage device

317 Integrated HDD/DVD non-volatile memory

318 Integrated HDD/DVD volatile memory

319 Integrated HDD/DVD energy storage means

321 Integrated HDD/DVD voltage regulation means

322 Integrated HDD/DVD interface connector

323 Integrated HDD/DVD power connector

324 Integrated HDD/DVD timing means

325 Integrated HDD/DVD printed circuit board

326 Integrated HDD/DVD chassis

400 Host system mounting chassis

411 Host system HDD interface connector

412 Host system HDD power connector

415 Host system HDD mounting screws

416 Host system HDD mounting rails

417 Host system HDD rail attachment method

421 Host system DVD interface connector

422 Host system DVD power connector

425 Host system DVD mounting method

426 Host system DVD mounting rails

427 Host system DVD rail attachment method

501 Host system integrated HDD/DVD interface connector

502 Host system integrated HDD/DVD power connector

505 Host system integrated HDD/DVD mounting method

506 Host system integrated HDD/DVD mounting rails

507 Host system integrated HDD/DVD rail attachment method

### DESCRIPTION OF THE PREFERRED EMBODIMENTS

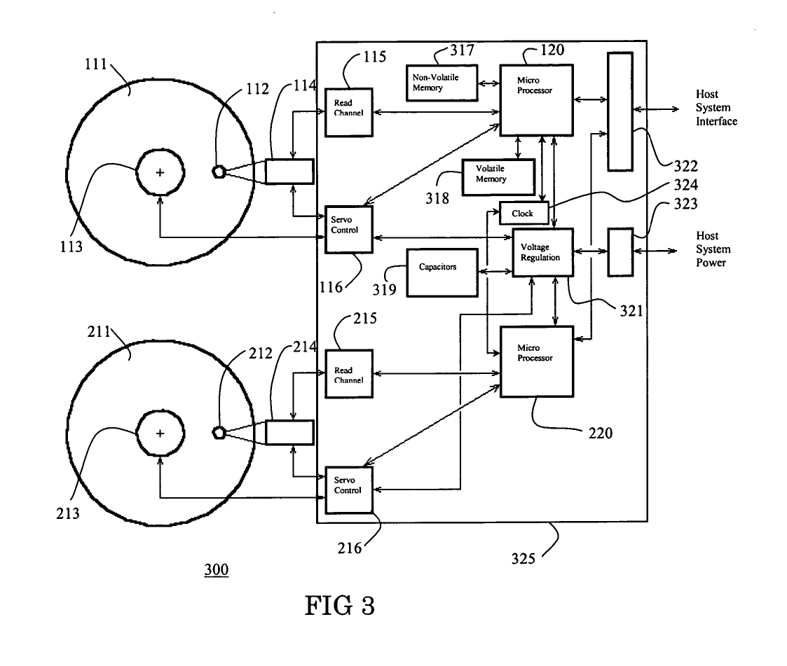

FIG. 3 is a schematic of the architecture of an integrated HDD/DVD device 300. The host system (not shown) provides power to the integrated device 300 via a single power connector 323. The host system passes commands and data to and from the integrated device 300 via a single interface connector 322. A single voltage regulation means 321 provides power per the required tolerances to the HDD microprocessor 120, the DVD microprocessor 220, the HDD servo control means 116, the DVD servo control means 216, and other electronic components. A single timing means 324 provides timing signals to the HDD microprocessor 120, the DVD microprocessor 220, the HDD servo control means 116, the DVD servo control means 216, the HDD read channel means 115, the DVD read channel means 215, and other electronic components. A single energy storage means 319 provides transient power during interruption of power to the required electronic components. A single printed circuit board 325 provides interconnecting circuitry between the interface connector 322, power connector 323, HDD microprocessor 120, DVD microprocessor 220, voltage regulation means 321, timing means 324, power-storage means 319, volatile memory 318, non-volatile memory 317, HDD servo control means 116, DVD servo control means 216, HDD read channel means 115, and the DVD read channel means 215.

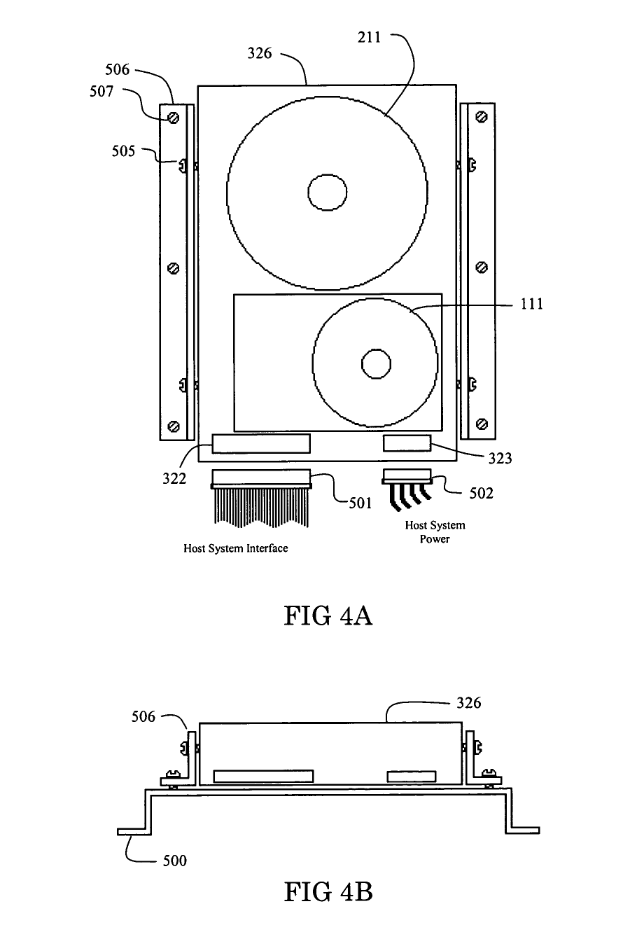

FIG. 4A shows a top view of the preferred method of attaching an integrated HDD/DVD device 300 into a host system (not shown). The integrated HDD/DVD chassis 326 is attached to host system mounting rails 506 via an attachment method 505. The host system mounting rails 506 are attached to the host system chassis 500 by an attachment method 507. A host system interface connector 501 connects to the integrated HDD/DVD interface connector 322. A host system power connector 502 connects to the integrated HDD/DVD power connector 323.

FIG. 4B shows the end view of the host system chassis 400, onto which the integrated HDD/DVD chassis 326 is mounted.

### Conclusion

The integrated HDD/DVD data storage device eliminates redundant components to increase reliability, assembly complexity and host system size. This provides the ideal solution where the complimentary functions of a large and fast HDD data storage and removable optical (DVD) data storage are required.

1. A disk drive, comprising:
a first read or write head,
a first positioning mechanism for the first head,
a first spindle motor for rotating a disk having a recording surface,
a first microprocessor for controlling the operation of the first head, first positioning mechanism, first spindle motor, and communication with a host device,
a second read or write head,
a second positioning mechanism for the second head,
a second spindle motor for rotating a disk having a recording surface,
a second microprocessor for controlling the operation of the second head, second positioning mechanism, second spindle motor, and communication with a host device, and
a single electronic interface connection which transfers communications to and from the host device and both the first and second microprocessor.

2. A disk drive, comprising:
a first read or write head,
a first positioning mechanism for the first head,
a first spindle motor for rotating a disk having a recording surface,
a first microprocessor for controlling the operation of the first head, first positioning mechanism, first spindle motor, and communication with a host device,
a second read or write head,
a second positioning mechanism for the second head,
a second spindle motor for rotating a disk having a recording surface,
a second microprocessor for controlling the operation of the second head, second positioning mechanism, second spindle motor, and communication with a host device, and
a single electronic power connection which transfers electronic power from the host device to both the first and second microprocessor.

3. A disk drive, comprising:
a first read or write head,
a first positioning mechanism for the first head,
a first spindle motor for rotating a disk having a recording surface,
a first microprocessor for controlling the operation of the first head, first positioning mechanism, first spindle motor, and communication with a host device,
a second read or write head,
a second positioning mechanism for the second head,
a second spindle motor for rotating a disk having a recording surface,
a second microprocessor for controlling the operation of the second head, second positioning mechanism, second spindle motor, and communication with a host device, and
a single printed circuit board which provides electrical interconnecting circuitry between a host device electronic interface and both the first and second microprocessors

4. A disk drive, comprising:
a first read or write head,
a first positioning mechanism for the first head,
a first spindle motor for rotating a disk having a recording surface,
a first microprocessor for controlling the operation of the first head, first positioning mechanism, first spindle motor, and communication with a host device,
a second read or write head,
a second positioning mechanism for the second head,
a second spindle motor for rotating a disk having a recording surface,
a second microprocessor for controlling the operation of the second head, second positioning mechanism, second spindle motor, and communication with a host device, and
a single mounting means for attaching the drive chassis to the host device chassis.
